(19) United States
(12) Patent Application Publication
(10) Pub. No.: US 2018/0295476 A1
(43) Pub. Date: Oct. 11, 2018

(54) Location-based Services

(71) Applicant: Sky CP Limited, Middlesex (GB)

(72) Inventors: Stephen STEWART, Middlesex (GB); Oliver SQUIRES, Middlesex (GB); Alex MANNING, Middlesex (GB)

(73) Assignee: Sky CP Limited, Middlesex (GB)

(21) Appl. No.: 15/567,583

(22) PCT Filed: Apr. 20, 2016
(86) PCT No.: PCT/GB2016/051080

§ 371 Date: Oct. 18, 2017

(30) Foreign Application Priority Data
Apr. 21, 2015 (GB) 1506745.7

(51) Int. Cl. H04W 4/029

(52) U.S. Cl. CPC H04W 4/029; H04W 88/02

(57) ABSTRACT

A location-based system comprises a display (1) and a wireless beacon (2) in close proximity. A beacon ID transmitted by the beacon (2) changes in synchronism with a change in content of the display (1). A mobile device (4) in the vicinity responds to the change in the beacon ID by changing content or services provided to the user (5). This system may enhance the applications of a micro-location system by providing time-varying services.

### FIELD OF THE INVENTION

The present invention relates to a location-based service, in which a beacon transmits a location signal for notifying a mobile application of its proximity to a location.

### BACKGROUND OF THE INVENTION

One example of such a location-based service is the iBeacon (RTM) system specified by Apple Inc., in which wireless transmitters at specific physical locations transmit a periodic beacon signal, using the Bluetooth Low Energy (BLE) standard. The beacon signal includes an ID which may be customised so as to uniquely identify the location of the iBeacon.

An iBeacon-enabled mobile device may respond to the beacon signal by automatically starting an application, or triggering a process within an application, so as to provide a location-specific service. The iBeacon-enabled mobile device or application can monitor beacon signals at different ranges, down to about 50 cm. Hence, the system provides a micro-location service suitable for use indoors.

The location-specific service may provide information pertinent to the location, such as a special offer relevant to a retail location or information about an exhibit at a museum. The location-specific service may be targeted at the user of the mobile device, as the application may have access to user details. The service may be combined with a conventional display, such as an advertising board.

Other wireless beacon micro-location systems have been proposed, either based on the iBeacon (RTM) system or as alternatives. For example, the Gimbal Proximity (RTM) system uses BLE beacons based on the iBeacon specification, with additional features such as encryption and customer tracking. Android-based systems such as Datzing (RTM) have also been proposed. Hence, there is a perceived need to provide a system with improved functionality and flexibility.

### STATEMENT OF THE INVENTION

According to one aspect of the present invention, there is provided a method of providing a location based service at one or more locations, each location having a wireless beacon and a changeable display. The wireless beacon transmits a beacon ID that changes in synchronism with a change in the display. This may be achieved by connecting the wireless beacon and the display to a common controller, or by connecting the wireless beacon to the display so as to detect a change in the display and change the beacon ID accordingly. The beacon ID may correspond to a specific display on the changeable display, such as a specific advertisement.

A user at any one of the locations may have a mobile device that responds to a specific beacon ID by providing a location-based service. As the beacon ID changes with the display, so the location-based service may correspond to the display. The location-based service may provide additional functionality relating to the specific advertisement, such as a video demonstration of an advertised product or service, or the opportunity to order the advertised product or service.

According to another aspect of the present invention, there is provided a method of providing a location-based service at one or more locations, each location having a wireless beacon and a changeable display, where a change in the display is triggered by the presence of a mobile device at the location. The presence may be detected by the mobile device receiving a wireless beacon signal. The change may be triggered by detection of an identity associated with the mobile device. The identity may relate to the mobile device itself, a user of the mobile device and/or a mobile application installed on the mobile device. The identity may be unique or near-unique, at least in the context of the use described above. In one example, the display may change each time the same user visits the location. In another example, the display may change when the number of different users visiting the location satisfies a predetermined criterion, such as a number threshold.

Other aspects of the present invention include a computer program product and system for performing any of the above methods.

### BRIEF DESCRIPTION OF THE DRAWINGS

There now follows, by way of example only, a detailed description of embodiments of the present invention, with reference to the figures identified below.

FIG. 1 is a diagram of a location-based system according to an embodiment of the invention.

FIG. 2 is a diagram of a mobile device for use in the system.

FIG. 3 is a diagram of a controller for use in the system.

### DETAILED DESCRIPTION OF THE EMBODIMENTS

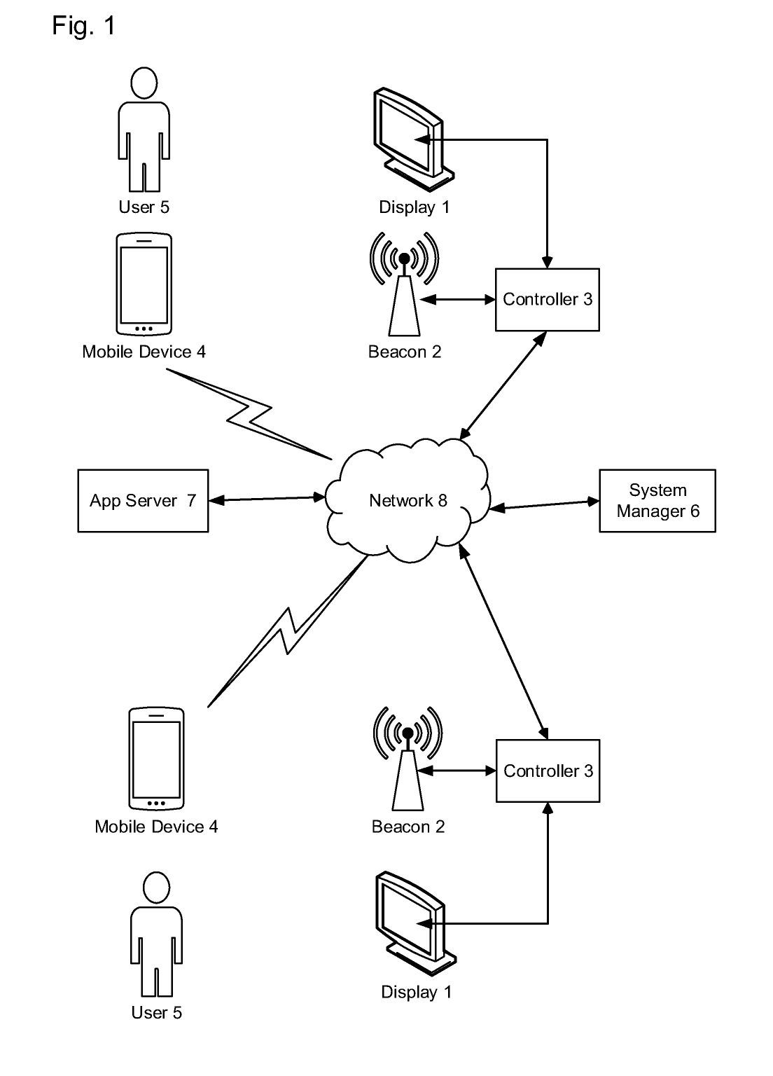

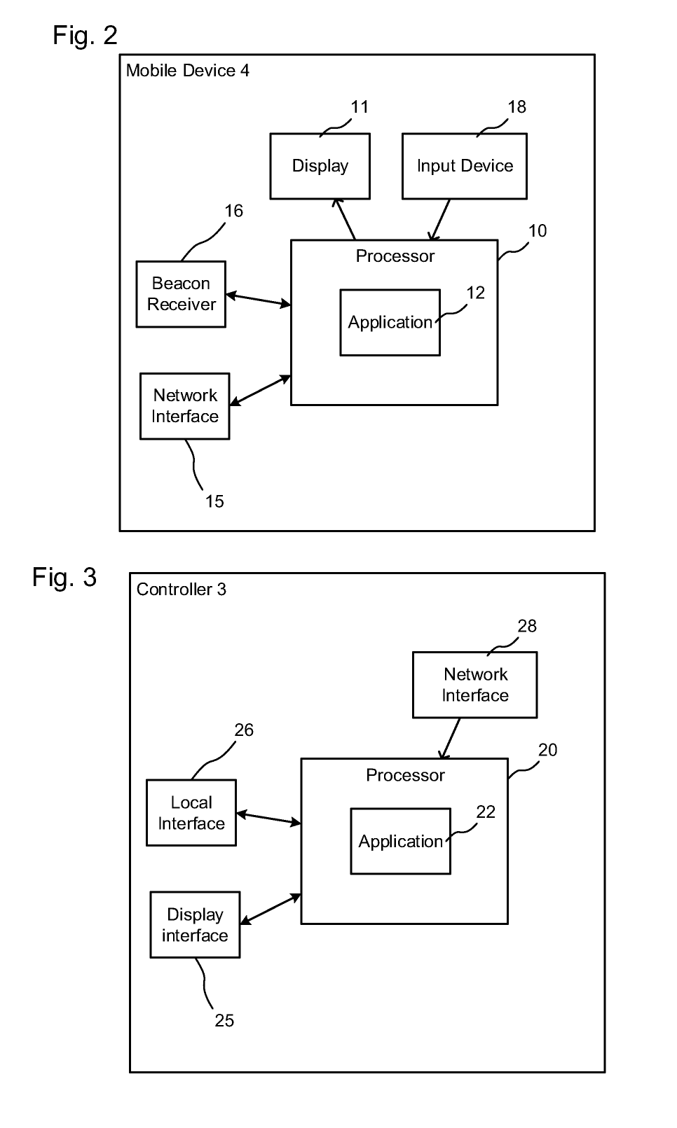

As shown in FIGS. 1 to 3, a location-based system in this embodiment comprises, at the or each location, a display 1 and a beacon 2 in close proximity. A user 5 has a mobile device 4 which is in the location of the display 1 and the beacon 2, preferably such that the mobile device 4 is in range of the beacon signal when the user 5 can perceive the display 1.

The mobile device 4 has a beacon receiver 16, such as a Bluetooth interface, for receiving the beacon signal. A mobile application 12 running on a processor 10 of the mobile device 4 responds to the beacon ID by providing a corresponding service to the user 5. The mobile device 4 is connected via a network interface 15, such as a mobile cellular or Wi-Fi (RTM) interface, to a network 8, such as the Internet. The mobile application 12 provides the beacon ID to the app server 7 and accesses content or services from the app server 7, linked to the beacon ID. The user may view the content and/or interact with the service provided by the mobile application 12, for example via a display 11 and/or input device 18.

A controller 3 may be connected to the display 1 and the beacon 2 at each location. Each controller 3 may be connected to a system manager 6, for example via the network 8.

This system may enhance the applications of a micro-location system by providing a time-varying service. For example, the display 1 may provide a time-varying display. The beacon 2 may be synchronised with the display 1, for example via the controller 3, so that a beacon signal transmitted by the beacon 2 includes a beacon ID which changes in synchronism with a change in the display 1. Each beacon ID may have a predetermined relationship with specific content to be provided by the display. The mobile application 12 may be configured to provide different location-based content or services corresponding to each beacon ID, which then corresponds to the content provided by the display 1.

The synchronised change in display 1 and beacon ID may be triggered by a time reference, for example periodically or at specified times of day. The time reference may be a time signal available at the controller 3. Alternatively, the synchronised change may be triggered by a trigger signal from a system manager 6 in communication with the controller 3 via the network 8.

Alternatively or additionally, the display 1 may change in response to detection of the mobile device 4 in the proximity of the beacon 2. In this case, the beacon ID need not change in synchronism with the display. For example, each mobile device 4 and/or instance of the mobile application 12 may be identified to the app server 7 by a unique ID, for example when communicating the detected beacon ID to the app server 7. If the app server 7 determines that the detected beacon ID has previously been associated with the same unique ID, the app server may communicate this to the system manager 6 so that the display 1 may be changed from a display previously available to the user 5 when the beacon ID was previously detected. This may enable the same user 5 to see a different display from the one previously seen at the same location.

In another example, the app server 7 may maintain a log of the number of different unique IDs associated with a particular detected beacon ID. When this number satisfies a predetermined criterion, such exceeding a predetermined threshold, the app server 7 may initiate a reward action, whereby the user receives a voucher or other reward via the mobile application 12. This event may be communicated to the system manager 6 so as to change the display 1, for example to alert the user 5 to the reward action.

### SYSTEM DETAILS—EXAMPLES

The beacon ID may be compatible with the iBeacon (RTM) specification, comprising the following customizable values:
Proximity UUID (128 bit, typically identifying the system operator)
Major (16 bit, typically identifying a general location)
Minor (16 bit, typically identifying a sub-location within the general location)
   The beacon ID may be changed by changing the Minor and/or Major value.

The controller 3 may communicate with the beacon 2 via a local interface 26 such as a USB interface. The change in beacon ID may be controlled by an application 22, for example a Node.JS web application, executed by a processor 20 of the controller 3. The application 22 may be configured by the system manager 6, for example via a network interface 28.

The system manager 6 may comprise a computer, preferably configurable via a local or remote user interface, such as a web interface.

The controller 3 may communicate with the display 1 via a display interface 25, the nature of which depends on the type of display 1. In one specific embodiment, the display 1 is a digital signage unit (DSU) that is programmed to provide a periodically changing display; the controller 3 may trigger the change in the display, or may respond to the change in display detected over the display interface 25. Alternatively, the display 1 may be a display screen arranged to display images generated by the controller 3 and the display interface 25 may be a video interface, for example a VGA, DVI-D or HDMI interface.

In another alternative, the display 1 may be a mechanically changeable display, such as a scrolling or rotating display. A detector may be attached to the display 1 and connected to the display interface 25, to enable the controller 3 to detect a change in the display 1 and change the beacon ID accordingly. This allows retrofitting of the system to an existing display 1. The detector may comprise an image detector or camera, enabling the controller 3 to detect the content of the display 1, for example by image recognition or watermark detection. The controller 3 may determine the beacon ID corresponding to the detected content. Alternatively, the detector may comprise a motion sensor or vibration sensor arranged to detect when the display 1 is changing.

The display 1, or at least the changeable part of the display 1, may be visual, audible, haptic and/or olfactory. Hence, the term ‘display’ is not limited to visual output.

The mobile device 4 may comprise a smartphone, tablet or other portable computing device, running a beacon-enabled operating system such as iOS (RTM), Android (RTM) or Windows Mobile (RTM). Where the beacons 2 are iBeacons (RTM), the operating system may be Android 4.3 or later, or iOS with support for Bluetooth 4.0.

The mobile application 12 and/or the application 22 of the controller 3 may comprise computer programs or software, which may be embodied as a computer program product in storage media, memory or signals. Alternative embodiments may be implemented as control logic in hardware, firmware, or software or any combination thereof.

### ALTERNATIVE EMBODIMENTS

The above embodiments are described purely by way of example and are not limiting on the scope of the invention. Functional parts shown as discrete items may be integrated together, or the functionality of individual items may be distributed across multiple entities or locations. For example, some or all of the functionality of the controller 3 may be integrated with the display 1, the beacon 2 and/or the system manager 6. Some or all of the functionality of the system manager 6 and app server 7 may be combined.

Alternative embodiments may be envisaged, which nevertheless fall within the scope of the following claims.

1. A method of providing a location-based service, comprising:
a. providing a display of changeable content at a location; and
b. transmitting a wireless beacon signal, including a beacon ID, at the location; wherein the beacon ID and display content are changed in synchronism.

2. The method of claim 1, wherein the beacon ID and display are changed in response to a trigger.

3. The method of claim 2, wherein the trigger is time-based.

4. The method of claim 1, including detecting a change in the display and changing the beacon ID in response thereto.

5. The method of claim 4, wherein the display is a mechanically changeable display.

6. The method of claim, wherein the display is a digital signage unit (DSU).

7. The method of claim 1, where there is a predetermined relationship between the beacon ID and the content of the display.

8. The method of claim 1 including receiving the beacon signal at a mobile device and providing a service or content at the mobile device dependent on the beacon ID.

9. The method of claim 8, wherein the service or content is provided by a mobile application in communication with an application server.

10. The method of claim 8, including changing the content of the display in response to detection of the mobile device.

11. A method of providing a location-based service, comprising:
a. providing a display of changeable content at a location; and
b. transmitting a wireless beacon signal, including a beacon ID, at the location; wherein the content of the display is changed in response to detection of a mobile device at the location.

12. The method of claim 11, wherein the content is changed in response to the mobile device receiving the wireless beacon signal.

13. The method of claim 11, wherein the content is selected according to an identity associated with the mobile device.

14-15 (canceled)

16. A system for providing a location-based service, the system comprising, at a location:
a. a display of changeable content; and
b. a wireless beacon arranged to transmit a wireless beacon signal, including a beacon ID;
the system being arranged such that the beacon ID and display content are changed in synchronism.

17. The system of claim 16, including a controller arranged to change the beacon ID in synchronism with the change in display content.

18. The system of claim 17, wherein the controller is arranged to change the beacon ID and display in response to a trigger.

19. The system of claim 18, wherein the trigger comprises a time reference.

20. The system of claim 16, including a detector arranged to detect a change in the display, the controller being arranged to change the beacon ID is response to detection of the change in the display.

21. The system of claim 20, wherein the display is a mechanically changeable display.

22. The system of claim, wherein the display is a digital signage unit (DSU).

23. The system of claim any one of claims 16, including a mobile device arranged to receive the beacon signal and to provide a service dependent on the beacon ID.

24. The system of claim 23, wherein the display is changed in response to detection of the mobile device.

25. A system for providing a location-based service, the system comprising, at a location:
a. a display of changeable content; and
b. a wireless beacon arranged to transmit a wireless beacon signal, including a beacon ID;
wherein the display content is arranged to change in response to detection of a mobile device at the location.

26. The system of claim 25, wherein the display content is arranged to change in response to the mobile device receiving the wireless beacon signal.

27. The system of claim 25, wherein the display content is selected according to an identity associated with the mobile device.
